(19) United States
(12) Patent Application Publication
(10) Pub. No.: US 2006/0048680 A1
(43) Pub. Date: Mar. 9, 2006

(54) Process for reducing creep in a gypsum plaster-based element, gypsum plaster-based composition and method for making a gypsum plaster-based element with reduced creep

(76) Inventors: Roger Arese, Isle sur La Sorgue (FR); Daniel Martin, Lyon (FR); Michel Rigaudon, Caromb (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/537,397

(22) PCT Filed: Dec. 2, 2003
(86) PCT No.: PCT/FR03/03556

§ 371 Date: Jun. 2, 2005

(30) Foreign Application Priority Data
Dec. 6, 2002 (FR) 0215427

(51) Int. Cl. C04B 28/26; C04B 24/00; C04B 14/00

(52) U.S. Cl. 106/603; 106/728; 106/732

(57) ABSTRACT

The invention relates to a process for reducing the sagging of a gypsum-based element, such as a gypsum board. This process comprises the introduction into the gypsum-based composition, before the setting and hardening of the latter, of tartaric acid or tartaric acid salt(s), in a quantity greater than 0.001% by weight with respect to the weight of the calcium sulphate semihydrate contained in the gypsum-based composition. The invention also relates to a gypsum-based composition for such an element. This composition comprises, in percentages by weight with respect to the weight of the calcium sulphate semihydrate in the composition, from 0.003% to 0.45% of tartaric acid or tartaric acid salt(s) and from 0.05% to 0.95% of boric acid or boric acid salt(s). Finally, the invention also relates to a gypsum-based element with reduced sagging, obtained by hydraulic setting and hardening of a composition according to the invention, the use of tartaric acid or tartaric acid salt(s) for reducing the sagging of a gypsum-based element as well as a process for manufacturing a gypsum-based element with reduced sagging.

The present invention relates to a process for reducing the sagging of a gypsum-based element, a gypsum-based composition for such an element and a process for manufacturing a gypsum-based element with reduced sagging. It is used in particular for the production of gypsum boards with reduced sagging.

U.S. Pat. No. 3,190,787 describes low-density gypsum boards containing boric acid in well-defined quantities, with a view, in particular, to eliminating the sagging of these boards.

The international application published under No. WO 99/08978 relates to a process for producing a set gypsum-containing product, in which trimetaphosphate ions are introduced into the gypsum-based composition in order to improve the mechanical strength, rigidity and dimensional stability of the set gypsum.

U.S. Pat. No. 4,645,548 relates to a process for producing gypsum boards, in which tartaric acid or one of its metallic salts are used as hydraulic setting retarders.

U.S. Pat. No. 6,352,585 relates to a gypsum-based casting composition intended for use in the dental field. This composition is composed of two parts, a first gypsum-based part, and a second water-based part, one and/or the other of these parts containing at least two acids which are chosen from the group constituted by oxalic, boric, phosphoric, citric, tartaric, sulphuric, acetic, formic, maleic, ascorbic, aspartic acids and their mixtures. The two parts are kept separate, then mixed at the time of casting; the mixture is then left to set.

In Examples 22, 38, 49 and 50 of this American patent, compositions are described, the first part of which is constituted by 100 g of gypsum and the second part comprises 30 g of water, in which, depending on the examples, 1 or 2 g of boric acid and 0.5 or 1 g of tartaric acid are dissolved.

In the construction field, sagging is due to the mechanical stresses to which the gypsum boards are subjected, most often under the action of their own weight. If there is high ambient hygrometry, the effects of these stresses are amplified and engender, over the course of time, a deformation of the board, which sags downwards. This phenomenon is amplified with the lightening of the products, and is particularly annoying; this is the case, for example, when gypsum boards are fixed as a ceiling. There is then a wavy profile between the board fixing points.

It was while seeking to reduce the sagging of gypsum boards that the Applicant discovered that a considerable reduction in sagging is obtained, when more than

0.001% by weight of tartaric acid or one of its salts, with respect to the weight of the calcium sulphate semihydrate, is introduced into the gypsum board during its preparation.

Such a result is very surprising to a person skilled in the art, as the scientific literature teaches that “additives [in particular tartaric and boric acid] have a detrimental effect on the sagging behaviour of the material at 97% [relative humidity], with the exception of malic acid.” See in this respect page 105 of the doctoral thesis of the University of Aix-Marseille III, Department of Process Engineering and Physico-Chemistry, entitled “Etude de 1'adsorption de 1'eau sur les cristaux de gypse et de son influence sur les propriétés mécaniques du plâtre pris pur et additivé”, presented publicly by Elisabeth Badens on 12 Jan. 1998.

Moreover, the Applicant has found that a synergistic effect is produced, in terms of anti-sagging effect, when tartaric acid or one or more of its salts is used in combination with boric acid or one or more of its salts (hydrosoluble), in a gypsum element.

Thus, a subject of the present invention is a process for reducing sagging in a gypsum-based element. It is used in particular for gypsum boards.

The process according to the invention comprises the introduction into the gypsum-based composition, before the latter sets and hardens in order to produce the gypsum-based element, of tartaric acid or tartaric acid salts, in a quantity greater than 0.001% by weight, preferably greater than 0.01%, with respect to the weight of the calcium sulphate semihydrate contained in the gypsum-based composition.

Another subject of the invention is a gypsum-based composition which makes it possible to obtain a gypsum-based element having reduced sagging. This composition can in particular be a composition for gypsum board.

The composition according to the invention comprises, in percentages by weight with respect to the weight of the calcium sulphate semihydrate in the composition, from 0.003% to 0.45% of tartaric acid or tartaric acid salt(s) and from 0.05% to 0.95% of boric acid or boric acid salts.

The invention also relates to a gypsum-based element, such as a gypsum board, having reduced sagging, and which is obtained by hydraulic setting and hardening of the gypsum-based composition according to the invention.

Yet another subject relates to the use of tartaric acid or one or more of its salts for reducing the sagging of a gypsum-based element, in particular a gypsum board.

Finally, a subject of the invention is also a process for manufacturing a gypsum-based element having reduced sagging, in which tartaric acid, or one or more of its salts, and boric acid or one or more of its salts are introduced into the gypsum-based composition before the latter sets and hardens in order to produce the gypsum-based element.

Other characteristics and advantages of the invention will now be described in detail in the disclosure which follows.

### DETAILED DISCLOSURE OF THE INVENTION

Process for Reducing Sagging According to the Invention

Thus, in order to reduce the sagging of the gypsum-based element, according to the invention, tartaric acid or one of its salts is introduced into the gypsum-based composition before the setting and hardening of the latter.

By “gypsum-based composition”, is understood here a standard gypsum composition, i.e. essentially constituted by gypsum.

By “gypsum”, is understood beta or alpha-type calcium sulphate semihydrate.

This gypsum can also contain calcium sulphate in the form of anhydrite.

By “tartaric acid” is understood here L, D, DL or meso tartaric acid as described in “The Merck Index—eleventh edition”. Of course, mixtures of two or more of these isomers can be used. Hence one can use a mixture of L and D tartaric acid, according to weight ratios varying from 5/95 to 95/5, preferably 30/70 to 70/30. One can also use a mixture of L, D and meso tartaric acid, according to weight ratios varying from 10-25/10-50/25-80, preferably 10-25/10-40/50-80.

The tartaric acid can be used in the form of a salt which can be a metallic salt or a quaternary ammonium salt.

As metallic salts, the salts formed with an alkali metal such as sodium or the salts formed with an alkaline-earth metal such as calcium can be mentioned.

The quantity of tartaric acid, or one or more of its salts, introduced into the gypsum composition is generally greater than 0.001% by weight with respect to the weight of calcium sulphate semihydrate contained in the composition for gypsum board.

Preferably, from 0.003% to 0.45% and preferably from 0.005% to 0.05% of tartaric acid or tartaric acid salt(s) are introduced into the gypsum-based composition, in percentages by weight with respect to the weight of calcium sulphate semihydrate present in the composition.

According to one embodiment of the invention, from 0.05% to 0.95% and preferably 0.2% to 0.8% of boric acid or boric acid salt(s) are moreover introduced into the gypsum-based composition, in percentages by weight with respect to the weight of the calcium sulphate semihydrate in the composition. This embodiment is particularly advantageous, as the combination of these two acids produces a synergistic effect on the anti-sagging effect induced.

The introduction of additives into the gypsum-based composition can be carried out either by dissolving them beforehand in the mixing water, or by mixing them in the form of gypsum powder, or by means of impregnation by soaking the set gypsum element in an aqueous solution containing the additives.

According to one embodiment of the invention, air is moreover introduced into the gypsum-based composition by adding a foam. This foam can be produced using any appropriate foaming agent, for example, the foaming agent with the formula ROSO₃M, as defined on page 14, line 20 to page 15, line 16, of the abovementioned international Application WO99/08978.

Preferably, a foaming agent comprising an alkali or alkaline-earth metal alkylsulphate is used. As alkali metal, potassium, lithium and, preferably, sodium can then be mentioned. As alkaline-earth metal, calcium and magnesium can be mentioned.

The particularly preferred foaming agent comprises an alkylsulphate of formula H(CH₂)ₙOSO₃ ⁻M⁺, in which n varies from 6 to 16 and the average number of carbon atoms in the alkylsulphate composition nₘ is comprised between 10 and 11, and M is a monovalent cation.

According to one embodiment of the invention, in order to further improve the anti-sagging effect, one or more alkali or alkaline-earth metal phosphates are introduced into the gypsum-based composition.

The quantity of alkali or alkaline-earth metal phosphate introduced is 0.5% maximum, and preferably below 0.2% by weight, with respect to the mass of calcium sulphate semihydrate.

As phosphate alkali metal, sodium, potassium and lithium can be mentioned.

As phosphate alkaline-earth metal, calcium and magnesium can be mentioned.

Preferably, the metal is sodium.

As phosphate, trimetaphosphate is preferably used.

Thus, the metallic phosphate particularly preferred is sodium trimetaphosphate.

Gypsum-Based Composition According to the Invention

The gypsum-based composition with reduced sagging according to the invention, comprises, in percentages by weight with respect to the weight of the calcium sulphate semihydrate in the composition, more than 0.001%, in particular from 0.003% to 0.45% of tartaric acid or tartaric acid salt(s), and from 0.05% to 0.95% of boric acid or boric acid salt(s).

According to a preferred embodiment of the invention, the gypsum-based composition comprises from 0.005% to 0.05% of tartaric acid or tartaric acid salt(s), and from 0.2% to 0.8% of boric acid or boric acid salt(s).

Still more preferentially, the composition comprises from 0.02% to 0.03% of tartaric acid or tartaric acid salt(s), and from 0.4% to 0.7% of boric acid or boric acid salt(s).

The gypsum-based composition according to the invention preferably comprises, as has been described with respect to the process according to the invention, an alkali or alkaline-earth metal phosphate.

The gypsum-based composition according to the invention can moreover comprise additives used in a standard fashion in gypsum-based compositions and well known to a person skilled in the art. In this respect, setting accelerators, setting retarders, binding agents, adhesive agents, plasticizers, water retainers, air-entraining agents, thickening agents, bactericides, fungicides, pH adjusters, reinforcing materials, flame-retardants, waterproofing agents and/or fillers can be mentioned.

In the case of use for producing a gypsum board, the composition according to the invention has the advantage of not altering the adhesion between the cardboard and the gypsum constituting the board.

Gypsum Board According to the Invention

The gypsum-based composition according to the invention, can advantageously be made into board, in order to produce, after hydraulic setting and hardening, a gypsum board with reduced sagging.

Process for Manufacturing a Gypsum-Based Element with Reduced Sagging According to the Invention

According to the invention, the manufacture of a gypsum-based element, such as a gypsum board, having reduced sagging, comprises, in addition to the standard stages, the introduction of tartaric acid, or one or more of its salts, of boric acid, or one or more of its salts, into the gypsum-based composition, before the hydraulic setting and hardening of the latter.

### EXAMPLES

The following examples illustrate the present invention without however limiting its scope.

### Example 1

A 0.316×0.316 m² mini-board having a thickness of 6.5 mm and a density of 0.78 was prepared from Carpentras gypsum, which is a gypsum obtained by flash calcining of a natural gypsum having a minimum gypsum content of 80%.

This board is prepared in the following manner: a foam is prepared by stirring for one minute in a Hamilton Beach type foam generator regulated at a voltage of 55 volts:
2.5 ml of a 50 g/l solution of a foaming agent of formula ROSO₃M, as defined on page 14, line 20 to page 15, line 16, of international Application 99/08978.
80 ml of water at 22° C.

The foam is then introduced into a mixture of 400 g of water at a temperature of 50° C. and 600 g of gypsum at a temperature of 22° C. The gypsum paste is deposited between two sheets of cardboard. The excess after filling is eliminated. The mini-board is then dried in a dryer at a temperature increasing steadily from 100° C. to 170° C. in 6 minutes, then decreasing steadily from 170° C. to 90° C. in 16 minutes until a control board, called board T is produced.

### Example 2

Boards 1 to 16 are prepared, according to the operating procedure of Example 1, by introducing beforehand into the 400 g of water at 50° C., the acids indicated in the table below, with the following percentages with respect to the weight of the gypsum:

TABLE I

| | L tartaric acid | boric acid |
|---|---|---|
| | (in % with respect to the weight | (in % with respect to the |
| Board No. | of the gypsum) | weight of the gypsum) |
| 1 | 0.01 | — |
| 2 | 0.025 | — |
| 3 | 0.05 | — |
| 4 | 0.16 | — |
| 5 | 0.30 | — |
| 6 | 0.475 | — |
| 7 | — | 0.15 |
| 8 | — | 0.16 |
| 9 | — | 0.17 |
| 10 | — | 0.25 |
| 11 | — | 0.30 |
| 12 | — | 0.45 |
| 13 | — | 0.475 |
| 14 | 0.01 | 0.15 |
| 15 | 0.05 | 0.25 |
| 16 | 0.025 | 0.45 |

### Example 3

Sagging measurements were carried out on boards T and 1 to 16 prepared in Examples 1 and 2, according to the standard ASTM C 473-95 modified as follows: each board, 316 mm wide (instead of 305 mm) is suspended between two blades at a centre distance of 300 mm (instead of 584 mm) under a stress equivalent to 1.5 times the dry weight of the board (760 g). The sag is measured after 24, 48 and 65 hours. For practical reasons, the sagging values noted in the examples correspond to the sag reached after 65 hours. The sagging is measured to an accuracy of 3%.

The results are recorded in Table II below:

TABLE II

| Board No. | Sagging measured in mm |
|---|---|
| T | 9.29 |
| 1 | 4.66 |
| 2 | 3.81 |
| 3 | 3.17 |
| 4 | 2.09 |
| 5 | 1.51 |
| 6 | 1.08 |
| 7 | 2.60 |
| 8 | 2.54 |
| 9 | 2.48 |
| 10 | 2.13 |
| 11 | 1.96 |
| 12 | 1.59 |
| 13 | 1.54 |
| 14 | 1.50 |
| 15 | 1.10 |
| 16 | 0.76 |

The results obtained demonstrate:
the effect of tartaric acid on sagging (boards 1 to 6 with respect to board T);
the effect of boric acid on sagging (boards 7 to 13 with respect to board T);
the synergistic effect linked to a combination of tartaric and boric acids (boards 1, 4, 7, 8 with respect to board 14, or boards 3, 5, 10, 11 with respect to board 15).

Similarly, comparison of the results for the boards 2, 6, 12, 13 with those for board 16, shows a synergistic effect which is expressed by a sagging of the gypsum board which is situated under the millimetre mark.

This synergistic effect can also be expressed by comparing the improvement in the reduction of sagging obtained by the tartaric acid/boric acid combination with dose of additives.

Table III below expresses this gain in %:

TABLE III

| | Quantity of additives | |
|---|---|---|
| | (in % with respect to the weight of | gain produced |
| Boards compared | the gypsum) | by the synergy |
| 14/4 | 0.16 | 28% |
| 14/8 | 0.16 | 41% |
| 15/5 | 0.30 | 27% |
| 15/11 | 0.30 | 44% |
| 16/6 | 0.475 | 30% |
| 16/13 | 0.475 | 51% |

### Example 4

In this example, in order to study the effect of an addition of sodium trimetaphosphate (NaTMP), boards 17 to 22 were prepared according to the operating method indicated in Example 2, with the characteristics shown in Table IV below:

TABLE IV

| | L tartaric acid | boric acid | NaTMP |
|---|---|---|---|
| Board no. | (in %) | (in %) | (in %) |
| 17 | 0.025 | 0.4 | — |
| 18 | — | — | 0.05 |
| 19 | — | — | 0.1 |
| 20 | 0.025 | 0.4 | 0.01 |
| 21 | 0.025 | 0.4 | 0.05 |
| 22 | 0.025 | 0.4 | 0.1 |

### Example 5

Sagging measurements were carried according to the standard ASTM C 473-95 modified as described previously in Example 3.

The results are recorded in Table V below:

TABLE V

| Board No. | Sagging measured in mm |
|---|---|
| T | 9.30 |
| 17 | 0.83 |
| 18 | 0.89 |
| 19 | 0.75 |
| 20 | 0.73 |
| 21 | 0.71 |
| 22 | 0.51 |

By comparing the results for boards 17 to 22, it is noted that it is advantageous to combine the tartaric and boric acids with NaTMP, as this results in virtually zero sagging.

### Example 6

A 0.316×0.316 m² mini-board having a thickness of 6.5 mm and a density of 0.78 was prepared according to the operating method described in Example 1, but starting with Cilegon gypsum, which is a gypsum obtained by flash calcining of a natural gypsum having a minimum gypsum content of 90%.

This control board is called board T′.

### Example 7

Boards 23 to 30 were prepared according to the operating method of Example 6, by introducing beforehand into the 400 g of water at 50° C., the additives indicated in Table VI below, with the following percentages with respect to the weight of the gypsum:

TABLE VI

| | L tartaric acid | Sodium trimetaphosphate |
|---|---|---|
| | (in % with respect to the | (in % with respect to the weight of |
| Board No. | weight of the gypsum) | the gypsum) |
| 23 | 0.01 | |
| 24 | 0.02 | — |
| 25 | 0.04 | |
| 26 | | 0.01 |
| 27 | — | 0.02 |
| 28 | — | 0.04 |
| 29 | 0.01 | 0.01 |
| 30 | 0.02 | 0.02 |

### Example 8

Sagging measurements were carried out on boards T′ and 23 to 30 prepared in Examples 11 to 12, according to the standard ASTM C 473-95 modified according to the description of Example 3.

The sagging values noted in the examples correspond to the sag reached after 65 hours.

The sagging is measured to an accuracy of 3%.

The results are recorded in Table VII below:

TABLE VII

| Board No. | Sagging measured in mm |
|---|---|
| T′ | 9.50 |
| 23 | 2.20 |
| 24 | 1.48 |
| 25 | 1.13 |
| 26 | 1.51 |
| 27 | 1.15 |
| 28 | 0.73 |
| 29 | 1.02 |
| 30 | 0.66 |

Comparison of the results for boards 24, 27 and 29 show a synergistic effect linked to the combination of tartaric acid and sodium trimetaphosphate.

Similarly, comparison of the results for boards 25, 28 and 30 show that the combination of tartaric acid and sodium trimetaphosphate produces a synergistic effect which is expressed by a sagging of the gypsum board situated under the millimetre mark.

This synergistic effect can also be expressed by comparing the improvement in the reduction of sagging obtained by the tartaric acid/sodium trimetaphosphate combination with respect to the solution of tartaric acid alone or sodium trimetaphosphate alone, for the same overall dose of additives.

Table VIII below expresses this gain in %:

TABLE VIII

| | Quantity of additives | |
|---|---|---|
| | (in % with respect to the | % gain produced by the |
| Boards compared | weight of the gypsum) | synergy |
| 29/24 | 0.02 | 31% |
| 29/27 | 0.02 | 11% |
| 30/25 | 0.04 | 41% |
| 30/28 | 0.04 | 10% |

### Example 9

In this example, in order to allow comparison of the effectiveness of L, D, DL or meso tartaric acids, these acids being used alone, boards 31 to 41 were prepared according to the operating method indicated in Example 6, with the following characteristics:

TABLE IX

| | | | | meso |
|---|---|---|---|---|
| | L tartaric acid | D tartaric acid | DL tartaric | tartaric acid |
| Board no. | (in %) | (in %) | acid (in %) | (in %) |
| 31 | 0.01 | | | |
| 32 | 0.02 | | | |
| 33 | 0.04 | | | |
| 34 | | 0.01 | | |
| 35 | | 0.02 | | |
| 36 | | 0.04 | | |
| 37 | | | 0.01 | |
| 38 | | | 0.02 | |
| 39 | | | | 0.01 |
| 40 | | | | 0.02 |
| 41 | | | | 0.04 |

### Example 10

Sagging measurements were carried according to the standard ASTM C 473-95 modified as described previously in Example 3.

The results are recorded in Table X below:

TABLE X

| Board No. | Sagging measured in mm |
|---|---|
| T′ | 9.50 |
| 31 | 1.95 |
| 32 | 1.57 |
| 33 | 1.35 |
| 34 | 1.92 |
| 35 | 1.51 |
| 36 | 1.22 |
| 37 | 1.68 |
| 38 | 1.31 |
| 39 | 2.57 |
| 40 | 2.29 |
| 41 | 1.87 |

It can be noted that L, D, DL and meso tartaric acids all lead to an appreciable reduction in sagging.

### Example 11

In this example, in order to allow a comparison of the effectiveness of L tartaric acid with that of D tartaric acid, these acids being used in combination with boric acid, boards 42 and 43 were prepared according to the operating method indicated in Example 2, with the characteristics shown in Table XI below:

TABLE XI

| Board no. | L tartaric acid (in g) | D tartaric acid (in g) | boric acid (in g) |
|---|---|---|---|
| 42 | 0.05 | — | 0.25 |
| 43 | — | 0.05 | 0.25 |

### Example 12

Sagging measurements were carried according to the standard ASTM C 473-95 modified as described previously in Example 3.

The results are recorded in Table XII below:

TABLE XII

| Board No. | Sagging measured in mm |
|---|---|
| T | 9.29 |
| 42 | 1.10 |
| 43 | 1.12 |

It is therefore noted that D tartaric acid is as effective as L tartaric acid and that it also gives rise to a distinct improvement in the anti-sagging effect when it is combined with boric acid.

### Example 13

Boards 44 to 53 were prepared according to the operating method of Example 6, by introducing beforehand into the 400 g of water at 50° C., the additives indicated in Table XIII below, with the following percentages with respect to the weight of the gypsum:

| | | Meso tartaric | |
|---|---|---|---|
| | L tartaric acid | acid | D tartaric acid |
| Board n^{o} | (in %) | (in %) | (in %) |
| 44 | 0.04 | | |
| 45 | | 0.04 | |
| 46 | | | 0.04 |
| 47 | 0.02 | 0.02 | |
| 48 | 0.02 | | 0.02 |
| 49 | | 0.02 | 0.02 |
| 50 | 0.013 | 0.013 | 0.013 |
| 51 | 0.027 | 0.007 | 0.007 |
| 52 | 0.007 | 0.027 | 0.007 |
| 53 | 0.007 | 0.007 | 0.027 |

### Example 14

Sagging measurements were carried according to the standard ASTM C 473-95 modified as described previously in Example 3.

The results are recorded in Table XIV below:

TABLE XIV

| Board n^{o} | Sagging measured in mm |
|---|---|
| T′ | 9.50 |
| 44 | 1.27 |
| 45 | 1.93 |
| 46 | 1.19 |
| 47 | 1.41 |
| 48 | 1.42 |
| 49 | 1.22 |
| 50 | 1.28 |
| 51 | 1.21 |
| 52 | 1.01 |
| 53 | 1.06 |

One can conclude from the results thus obtained that:
L, D and meso tartaric acids, when added alone, all lead to a noticable decrease of sagging (boards 44 to 46 when compared to board T′);
L, D and meso tartaric acids mixture is efficient, especially when D and meso amounts are greater than L amounts.

### Example 15

A 0.316×0.316 m² mini-board having a thickness of 6.5 mm and a density of 0.78 was prepared according to the operating method described in Example 1, but starting with a second Cilegon gypsum, which is a gypsum obtained by flash calcining of a natural gypsum having a minimum gypsum content of 90%.

This control board is called board T″.

### Example 16

In this example, in order to compare efficiency of L, D, meso tartaric acids, alone or in admixture, these acids being used in combination with boric acid one has prepared boards 54 to 61 according to the operating method described in Example 2, with the characteristics shown in Table XV below:

TABLE XV

| Board | L tartaric acid | Meso tartaric acid | D tartaric acid | boric acid |
|---|---|---|---|---|
| n^{o} | (in %) | (in %) | (in %) | (in %) |
| 54 | 0.04 | | | |
| 55 | 0.04 | | | 0.4 |
| 56 | | 0.04 | | |
| 57 | | 0.04 | | 0.4 |
| 58 | | | 0.04 | |
| 59 | | | 0.04 | 0.4 |
| 60 | 0.007 | 0.013 | 0.019 | |
| 61 | 0.007 | 0.013 | 0.019 | 0.4 |

### Example 17

Sagging measurements were carried according to the standard ASTM C 473-95 modified as described previously in Example 3.

The results are recorded in Table XVI below:

TABLE XVI

| Board n^{o} | Sagging measured in mm |
|---|---|
| T″ | 7.7 |
| 54 | 1.09 |
| 55 | 0.69 |
| 56 | 1.75 |
| 57 | 1.07 |
| 58 | 0.91 |
| 59 | 0.82 |
| 60 | 1.00 |
| 61 | 0.72 |

The results thus obtained, when one considers combinations with boric acid, show that:
tartaric acid and boric acid in admixture allow a synergie;
L, D and meso tartaric acids mixtures are efficient, especially with a higher amount of D.

### Example 18

A 0.316×0.316 m² mini-board having a thickness of 12.5 mm and a density of 0.80 was prepared with a gypsum from Ottmarsheim, which is a gypsum obtained by indirect calcining in a rotating furnace of a synthetic gypsum obtained by desulfuration of flue gas of thermal power plant having a minimum gypsum content of 98%.

This board is prepared in the following manner: a foam is prepared by stirring for one minute in a Hamilton Beach type foam generator regulated at a voltage of 55 volts:
2.5 ml of a 50 g/l solution of a foaming agent of formula ROSO₃M, as defined on page 14, line 20 to page 15, line 16, of international Application 99/08978.
80 ml of water at 22° C.

The foam is then introduced into a mixture of 400 g of water at a temperature of 50° C. and 600 g of gypsum at a temperature of 22° C. The gypsum paste is deposited between two sheets of cardboard. The excess after filling is eliminated. The mini-board is then dried in a dryer at a temperature increasing steadily from 100° C. to 170° C. in 6 minutes, then decreasing steadily from 170° C. to 90° C. in 16 minutes. When dry the board is soaked in 5000 ml of deionised water until its weight is constant and then the board is dried at 45° C. until a control board, called board T′″ is produced.

### Example 19

Board 62 was prepared according to the operating method of Example 18, by introducing beforehand into the 5000 g of water 28 g of L tartaric acid.

### Example 20

Sagging measurements were carried out on boards T′″ and 62 prepared in Examples 18 and 19, according to the standard ASTM C 473-95 modified as follows: each board, 316 mm wide (instead of 305 mm) is suspended between two blades at a centre distance of 300 mm (instead of 584 mm) under a stress equivalent to 1.5 times the dry weight of the board (760 g). The sag is measured after 24, 48 and 65 hours. For practical reasons, the sagging values noted in the examples correspond to the sag reached after 65 hours. The sagging is measured to an accuracy of 3%.

Results are found in Table XVII below.

TABLE XVII

| Board n^{o} | Sagging measured in mm |
|---|---|
| T′′′ | 0.81 |
| 62 | 0.29 |

Results show the benefits obtained on sagging with tartaric acid when the set plaster element is impregnated by soaking in an aqueous tartaric acid solution.

1. Gypsum board with reduced sagging, obtained by hydraulic setting and hardening of a gypsum-based composition comprising, in percentages by weight with respect to the weight of the calcium sulphate semihydrate in the composition, from 0.003% to 0.45% of tartaric acid or tartaric acid salt(s) and from 0.05% to 0.95% of boric acid or boric acid salt(s).

2. Gypsum board according to claim 1, comprising, in percentages by weight with respect to the weight of the calcium sulphate semihydrate in the composition, from 0.005% to 0.05% of tartaric acid or tartaric acid salt(s) and from 0.2% to 0.8% of boric acid or boric acid salt (s).

3. Gypsum board according to claim 1, comprising, in percentages by weight with respect to the weight of the calcium sulphate semihydrate in the composition, from 0.02% to 0.03% of tartaric acid or tartaric acid salt(s) and from 0.4% to 0.7% of boric acid or boric acid salt (s).

4. Gypsum board according to claim 1, wherein the tartaric acid comprises a mixture of L and D forms.

5. Gypsum board according to claim 1, wherein the tartaric acid comprises a mixture of L, D and meso forms.

6. Gypsum board according to claim 1, also comprising a foaming agent.

7. Gypsum board according to claim 6, wherein the foaming agent is an alkali or alkaline-earth metal alkylsulphate, preferably an alkylsulphate of formula H(CH₂)ₙOSO₃⁻M⁺, in which n is from 6 to 16 and the average number of carbon atoms in the alkylsulphate composition nₘ is comprised between 10 and 11, and M is a monovalent cation.

8. Gypsum board according to claim 1, also comprising an alkali or alkaline-earth metal phosphate.

9. Gypsum board according to claim 8, wherein it contains at the most 0.5% and preferably less than 0.2% by weight, of said alkali or alkaline-earth metal phosphate with respect to the weight of the calcium sulphate semihydrate.

10. Gypsum board according to claim 8, wherein said alkali metal or alkaline-earth metal phosphate is sodium trimetaphosphate.

11. Process for manufacturing a gypsum board with reduced sagging according to claim 1, wherein tartaric acid, or one or more of its salts, and boric acid, or one or more of its salts, is introduced into the gypsum-based composition, before the hydraulic setting and hardening of the latter.

12. Process for manufacturing a gypsum board with reduced sagging according to claim 1, wherein tartaric acid, or one or more of its salts, and boric acid, or one or more of its salts, is introduced into the gypsum-based composition, after the hydraulic hardening of the latter, by soaking.

13. Process according to claim 11, comprising the introduction into the gypsum-based composition of tartaric acid or tartaric acid salt(s), in a quantity greater than 0.001% by weight with respect to the weight of the calcium sulphate semihydrate contained in the gypsum-based composition.

14. Process according to claim 11, wherein, in percentages by weight with respect to the weight of the calcium sulphate semihydrate in the composition, from 0.003% to 0.45% and preferably from 0.005% to 0.05% of tartaric acid or tartaric acid salt(s) are introduced into the gypsum-based composition.

15. Process according to claim 11, wherein in percentages by weight with respect to the weight of the calcium sulphate semihydrate in the composition, up to 0.95% and preferably from 0.2% to 0.8% of boric acid or boric acid salt(s) are also introduced into the gypsum-based composition.

16. Process according to claim 11, wherein the tartaric acid comprises a mixture of L and D forms.

17. Process according to claim 11, wherein the tartaric acid comprises a mixture of L, D and meso forms,

18. Process according to claim 11, wherein at least one foaming agent is also introduced into the gypsum-based composition.

19. Process according to claim 18, wherein the foaming agent comprises an alkali or alkaline-earth metal alkylsulphate, preferably an alkylsulphate of formula H(CH₂)ₙOSO₃⁻M⁺, in which n is from 6 to 16 and the average number of carbon atoms in the alkylsulphate composition, nₘ is comprised between 10 and 11, and M is a monovalent cation.

20. Process according to claim 11, wherein at least one alkali or alkaline-earth metal phosphate is also introduced into the gypsum-based composition.

21. Process according to claim 20, wherein said alkali or alkaline-earth metal phosphate is introduced in a quantity of 0.5% maximum, and preferably less than 0.2% by weight, with respect to the weight of the calcium sulphate semihydrate.

22. Process according to claim 20 wherein the alkali or alkaline-earth metal phosphate is sodium trimetaphosphate.

23. Use of tartaric acid or tartaric acid salt(s) for the reduction of the sagging of a gypsum-based element.
